(19) United States
(12) Patent Application Publication
(10) Pub. No.: US 2005/0232139 A1
(43) Pub. Date: Oct. 20, 2005

(54) Dual length block codes for multi-band OFDM

(75) Inventors: Jaiganesh Balakrishnan, Bangalore (IN); Anuj Batra, Dallas, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/109,567

(22) Filed: Apr. 19, 2005

Related U.S. Application Data
(60) Provisional application No. 60/564,032, filed on Apr. 20, 2004.

(51) Int. Cl. H04J 3/22; H04J 3/16; H04J 3/00; H04J 11/00

(52) U.S. Cl. 370/208; 370/465

(57) ABSTRACT

A transmitter 200 is provided. The transmitter 200 comprises a block encoder 203 operable to encode a bit stream using a first block size for a first portion of a message according to an orthogonal frequency division multiplex protocol and a second block size for a second portion of the message.

### CROSS-REFERENCE TO RELATED APPLICATIONS

This application claims priority to U.S. Provisional Application No. 60/564,032 filed Apr. 20, 2004, and entitled “Dual Length Block Codes for Multi-band OFDM” by inventors Jaiganesh Balakrishnan, et al, which is incorporated herein by reference for all purposes.

### STATEMENT REGARDING FEDERALLY SPONSORED RESEARCH OR DEVELOPMENT

Not applicable.

### REFERENCE TO A MICROFICHE APPENDIX

Not applicable.

### FIELD OF THE INVENTION

The present disclosure is directed to communications, and more particularly, but not by way of limitation, to a system and method for communicating employing dual length block codes for multi-band orthogonal frequency division multiplex (OFDM).

### BACKGROUND OF THE INVENTION

A network provides for communication among members of the network. Wireless networks allow connectionless communications. Wireless local area networks are generally tailored for use by computers and may employ sophisticated protocols to promote communications. Wireless personal area networks with ranges of about 10 meters are poised for growth, and increasing engineering development effort is committed to developing protocols supporting wireless personal area networks.

With limited range, wireless personal area networks may have fewer members and require less power than wireless local area networks. The IEEE (Institute of Electrical and Electronics Engineers) is developing the IEEE 802.15.3a wireless personal area network standard. The term piconet refers to a wireless personal area network having an ad hoc topology comprising communicating devices. The piconet may be coordinated by a piconet coordinator (PNC). Piconets may form, reform, and abate spontaneously as various wireless devices enter and leave each other's proximity. Piconets may be characterized by their limited temporal and spatial extent. Physically adjacent wireless devices may group themselves into multiple piconets running simultaneously.

One proposal to the IEEE 802.15.3a task group divides the 7.5 GHz ultra wide band (UWB) bandwidth from 3.1 GHz to 10.6 GHz into fourteen bands, where each band is 528 MHz wide. These fourteen bands are organized into four band groups each having three 528 MHz bands and one band group of two 528 MHz bands. An example piconet may transmit a first multi-band orthogonal frequency division multiplex (MB-OFDM) symbol in a first 312.5 nS duration time interval in a first frequency band of a band group, a second MB-OFDM symbol in a second 312.5 nS duration time interval in a second frequency band of the band group, and a third MB-OFDM symbol in a third 312.5 nS duration time interval in a third frequency band of the band group. Other piconets may also transmit concurrently using the same band group, discriminating themselves by using different time-frequency codes and a distinguishing preamble sequence. This method of piconets sharing a band group by transmitting on each of the three 528 MHz wide frequencies of the band group may be referred to as time frequency coding or time frequency interleaving (TFI). Alternately, piconets may transmit exclusively on one frequency band of the band group which may be referred to as fixed frequency interleaving (FFI). Piconets employing fixed frequency interleaving may distinguish themselves from other piconets employing time frequency interleaving by using a distinguishing preamble sequence. In practice four distinct preamble sequences may be allocated for time frequency interleaving identification purposes and three distinct preamble sequences may be allocated for fixed frequency interleaving. In different piconets different time-frequency codes may be used. In addition, different piconets may use different preamble sequences.

The structure of a message packet according to the Multi-band OFDM SIG physical layer specification comprises a preamble field, a header field, and a payload field. The preamble field may contain multiple instances of the distinct preamble sequence. The preamble field may be subdivided into a packet and frame detection sequence and a channel estimation sequence. The channel estimation sequence is a known sequence that may be used by a receiver to estimate the characteristics of the wireless communication channel to effectively compensate for adverse channel conditions. The preamble field, the header field, and the payload field may each be subdivided into a plurality of OFDM symbols.

### SUMMARY OF THE INVENTION

According to one embodiment, the present disclosure provides a transmitter that includes a block encoder. The block encoder is operable to encode a bit stream using a first block size for a first portion of a message according to an orthogonal frequency division multiplex protocol and a second block size for a second portion of the message.

In another embodiment, the present disclosure provides a method of communication. The method comprises block encoding a first portion of a message according to a multi-band orthogonal frequency division multiplex protocol into a plurality of blocks having a first length and block encoding a second portion of the message into one or more blocks having a second length. The second length being less than the first length.

In other embodiment, a communication system is provided. The communication system includes a first transceiver operable using a first block size to block encode a first portion of a message according to a multi-band orthogonal frequency division multiplex protocol. The first transceiver is operable using a second block size to block encode a second portion of the message. The first transceiver is further operable to transmit the message. The communication system also includes a second transceiver that is operable to receive the message using a block decoder to decode the first portion of the message based on the first block size. The second transceiver is also operable to decode the second portion of the message based on the second block size. The second transceiver distinguishes the first portion of the message from the second portion of the message based on a message length indication provided in the first portion of the message.

These and other features and advantages will be more clearly understood from the following detailed description taken in conjunction with the accompanying drawings and claims.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 depicts an exemplary wireless piconet for implementing an embodiment of the disclosure.

FIG. 2 is a block diagram of a transmitter in communication with a receiver according to an embodiment of the disclosure.

FIG. 3a is an illustration of a first block size according to an embodiment of the disclosure.

FIG. 3b is an illustration of a second block size according to an embodiment of the disclosure.

FIG. 4 is an illustration of two messages partitioned into a plurality of blocks of a first block size and one or two final blocks of a second block size according to an embodiment of the disclosure.

FIG. 5 an exemplary general purpose computer system having a radio transceiver card suitable for implementing the several embodiments of the disclosure.

### DETAILED DESCRIPTION OF THE PREFERRED EMBODIMENTS

It should be understood at the outset that although an exemplary implementation of one embodiment of the present disclosure is illustrated below, the present system may be implemented using any number of techniques, whether currently known or in existence. The present disclosure should in no way be limited to the exemplary implementations, drawings, and techniques illustrated below, including the exemplary design and implementation illustrated and described herein.

Block coding and convolution coding are forward error correction coding techniques that add redundancy to subject information to promote reception of a transmitted signal bearing the subject information. Block coding may provide an alternative to convolution coding and may be preferred to convolution coding in some communication environments. In other communication environments, block coding may be combined with convolutional coding, for example, Reed-Solomon codes may be concatenated with convolutional codes as an outer code to provide additional coding gain. The present disclosure teaches the use of a dual length block code in an orthogonal frequency division multiplex system. In block coding, a block of input information bits may be processed to produce a block of output information bits. The number of output bits is greater than the number of input information bits because of the redundancy introduced during the block encoding process. The ratio of input to output information bits may be referred to as the coding rate. For example, when 1800 input information bits are block encoded using 2400 output information bits, the coding rate is 3/4.

In block coding, messages are comprised of a sequence of complete blocks. Receivers may be required to receive a complete block of output information bits, for example 2400 bits, before decoding, which may produce a delay that is referred to as decoding latency. When the number of input information bits does not fill the last block, the last block may be filled by pad bits that carry no meaningful information. Longer block sizes provide more usable redundancy and are associated with greater coding gain or the ability to receive the transmitted message at a receiver. At the same time, longer block sizes lead to greater decoding latency. Additionally, longer block sizes lead to the use of more pad bits which constitute an overhead burden on the communications throughput rate. On average, the number of pad bits employed per message may be expected to be half of the block size. Using shorter block sizes reduces overhead associated with pad bits and reduces decoding latency. Shorter block sizes also have less coding gain. The use of dual length block sizes may obtain the advantages of both shorter and longer block sizes. The long block size may be employed for the leading portion of the message and the short block size may be employed at the end of the message. In some embodiments, more than two block sizes may be employed.

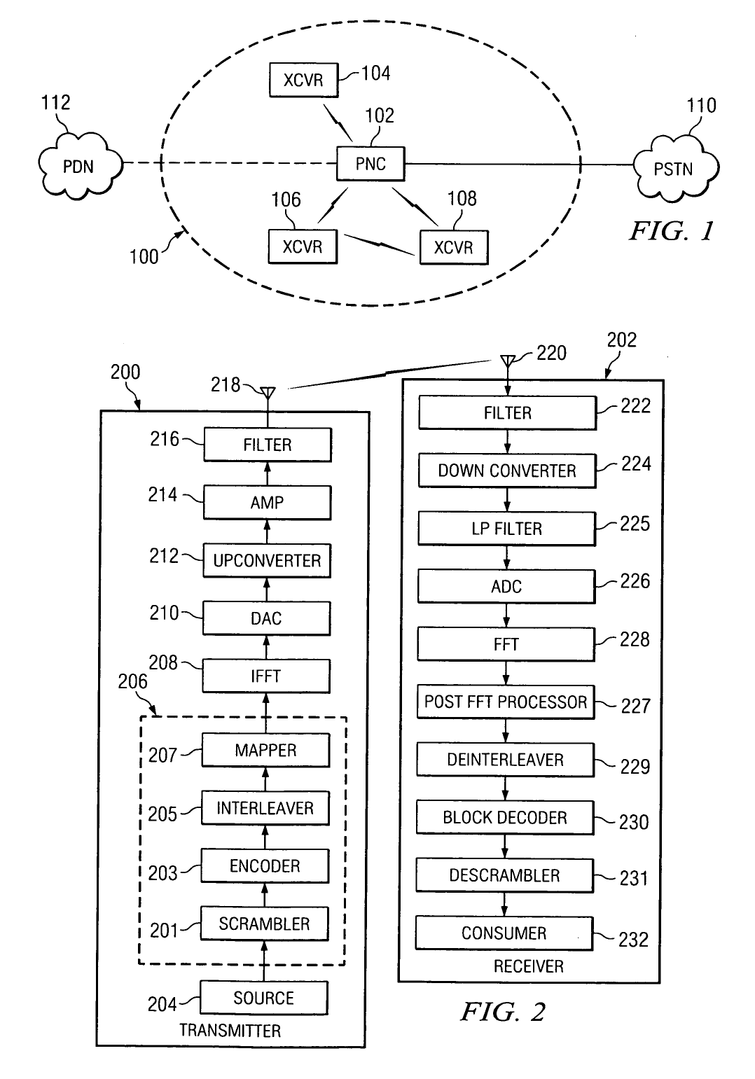

Turning now to FIG. 1, a block diagram depicts a piconet 100 formed by a number of cooperating electronic devices. A first transceiver 102 operates as the piconet controller for the piconet 100. A second transceiver 104, a third transceiver 106, and a fourth transceiver 108 operate as member of the piconet 100. The transceivers 102, 104, 106, and/or 108 may also be capable of operating as the piconet controller of the piconet 100, but are not depicted as carrying out that role. The first transceiver 102 may broadcast beacon messages, which may be referred to simply as beacons, to promote communication among the members of the piconet 100. The effective range of the beacon messages, and hence the effective boundary of the piconet 100, is depicted by a dashed line in FIG. 1. The first transceiver 102 may be connected to either a public switched telephone network 110 or to a public switched data network 112 whereby the members of the piconet 100, for example the transceivers 102, 104, 106, and 108, may communicate with the Internet or other network of interconnected communication devices. The transceivers 102, 104, 106, and 108 may wirelessly communicate according to the Multi-band orthogonal frequency division multiplex (OFDM) Alliance (MBOA) Special Interest Group (SIG) Physical layer specification, according to a WiMedia wireless personal area network protocol, and/or according to an Ecma wireless personal area network protocol. The wireless communications within the piconet 100 are transmitted and received as a sequence of orthogonal frequency division multiplex (OFDM) symbols. While the description above focuses on a wireless multi-band OFDM system, one skilled in the art will readily appreciate that the dual block size block coding concept may be applied to other OFDM systems. Further, the transceivers 102, 104, 106, and 108 may be operable for implementing the present disclosure.

Turning now to FIG. 2, a wireless transmitter 200 is shown in communication with a wireless receiver 202. Some conventional elements of transmitters and receivers may be omitted from FIG. 2 but will be readily apparent to one skilled in the art. The wireless transmitter 200 is suitable for transmitting OFDM symbols formatted according to embodiments of the present disclosure, and the wireless receiver 202 is suitable for receiving the OFDM symbols formatted according to embodiments of the present disclosure. A signal source 204 provides data to be transmitted to a modulator 206. The modulator 206 may comprise a spreader or scrambler component 201, a block encoder 203, an interleaver 205, and a mapper 207. The scrambler component 201 processes the data, which may be referred to as a bit stream, and provides input information data to the block encoder 203. The block encoder 203 encodes the input information data into output information data in a first block size for a first portion of the message and a second block size for a second portion of the message. Reed-Solomon, low density parity check, or other block coding mechanism or component may be employed to block encode the information data. An interleaver 205 may further process the bit stream. The output of the interleaver 205 is provided to a mapper 207 that mounts the output of the interleaver onto quadrature amplitude modulation (QAM) constellations for each of the tones. The modulator 206 provides the tones to an inverse fast Fourier transformer component 208 which translates the frequency domain representation of the data into a time domain representation of the same data.

The inverse fast Fourier transformer component 208 provides the time domain representation of the signal to a digital-to-analog converter 210 which converts the digital representation of the signal to an analog form. The analog form of the signal is a 528 MHz wide baseband signal. The digital-to-analog converter 210 provides the 528 MHz wide baseband signal to an up converter 212 which frequency shifts the 528 MHz wide baseband signal to the appropriate frequency band for transmission. The up converter 212 provides the up converted 528 MHz wide signal to an amplifier 214 which boosts the signal strength for wireless transmission. The amplifier 214 feeds the up converted, amplified, 528 MHz wide signal to a band-select filter 216, typically having a bandwidth of 1584 MHz, that attenuates any spurious frequency content of the up converted signal which lies outside the desirable three bands of the MB-OFDM signal. The band-select filter 216 feeds a transmitting antenna 218 which wirelessly transmits the up converted, amplified, band-select filtered 528 MHz wide signal.

The wireless signal is received by a receiving antenna 220. The receiving antenna 220 feeds the signal to a receiving band-select filter 222, typically having a bandwidth of 1584 MHz, that selects all three bands of the MB-OFDM signal from the entire bandwidth which the receiving antenna 220 is capable of receiving. The receiving band-select filter 222 feeds the selected MB-OFDM signal to a down converter 224 which frequency shifts the MB-OFDM signal to a 528 MHz baseband signal. The down converter 224 feeds the 528 MHz baseband signal to a base-band, low-pass filter 225, typically having a 528 MHz bandwidth. The base-band, low-pass filter 225 feeds the filtered 528 MHz baseband signal to an analog to digital converter 226 which digitizes the filtered 528 MHz baseband signal. The analog to digital converter 226 feeds the digitized 528 MHz baseband signal to a fast Fourier transformer 228 which converts the digitized 528 MHz baseband signal from the time domain to the frequency domain, decomposing the digitized 528 MHz baseband signal into distinct frequency domain tones. The fast Fourier transformer 228 feeds the frequency domain tones to a post FFT processing block 227 that performs frequency domain equalization to compensate for the multi-path channel, phase tracking and correction and also the demapping. The post FFT processing block 227 output feeds to a deinterleaver 229 that reverses the processing performed in the transmitter 200 by the interleaver 205. The deinterleaver 229 output feeds to a decoder component 230 that extracts the data from the blocks. The decoder component 230 output feeds to a descrambler component 231 which reverses the processing performed in the transmitter 200 by the scrambler component 201. The stream of data is then provided to a medium access control (MAC) component 232 which interprets and uses the stream of data.

The wireless transmitter 200 and wireless receiver 202 structures described above may be combined in some embodiments in a single device referred to as a transceiver, for example the transceivers 102, 104, 106, and 108 described above with reference to FIG. 1. While the transmitting bandpass filter 216 and the amplifier 214 are described as separate components, in some embodiments these functions may be integrated in a single component. Additionally, in some embodiments the up converted 528 MHz bandwidth signal may be bandpass filtered by the transmitting bandpass filter 216 before it is amplified by the amplifier 214. Other systems, components, and techniques may be implemented for these purposes which will readily suggest themselves to one skilled in the art and are all within the spirit and scope of the present disclosure. For example, in a very high data rate digital subscriber line system (VDSL), a hybrid may be provided to interface the transmitter 200, the receiver 202, or a transceiver to a digital subscriber line. In the VDSL example, the up converter 212, the first antenna 218, the second antenna 220, and the down converter 224 may be unnecessary.

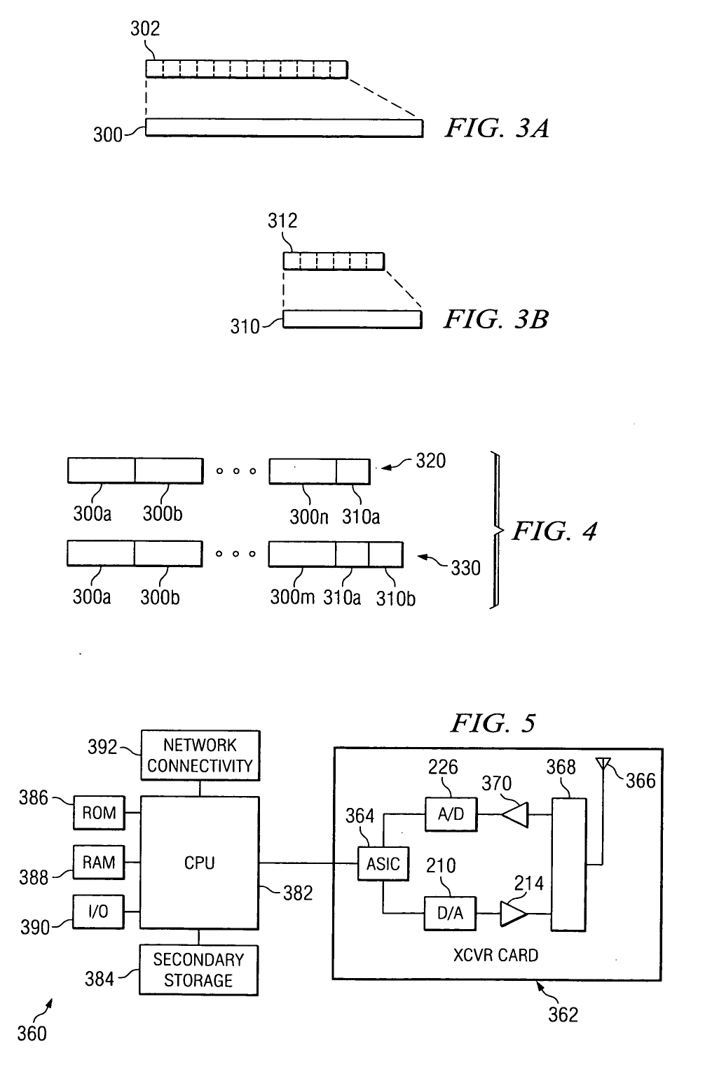

Turning now to FIG. 3a, a first block size is depicted. A first block 300 is depicted as composed of twelve OFDM symbols 302. The first block 300 is depicted as using ¾ coding, but in other embodiments other coding rates may be employed. Because in the multi-band OFDM system, the time-frequency codes have a period of 6 OFDM symbols, each block is an integer multiple of six OFDM symbols in length. At a 480 Mbps data rate, six OFDM symbols 302 may contain 900 source information bits. Based on a ¾ coding rate, block sizes may be integer multiples of 1200 bits. The minimum block sizes for other multi-band OFDM data rates is provided in Table 1 below.

TABLE 1

| Data Rate | Code Rate | Source bits | Minimum Block Size (¾ rate) |
|---|---|---|---|
| 480 Mbps | ¾ | 900 | 1200 |
| 400 Mbps | ⅝ | 750 | 1200 |
| 320 Mbps | ½ | 600 | 1200 |
| 200 Mbps | ⅝ | 375 | 600 |
| 160 Mbps | ½ | 300 | 600 |
| 106.7 Mbps | ⅓ | 200 | 600 |
| 80 Mbps | ½ | 150 | 300 |
| 53.3 Mpbs | ⅓ | 100 | 300 |

Turning now to FIG. 3b, a second block size is depicted. A second block 310 is depicted as composed of six OFDM symbols 312, the period of the multi-band OFDM system time-frequency codes. With reference to both FIGS. 3a and 3b, the first block size is 2400 bits and the second block size is 1200 bits. The first block size may be employed to block code the initial portion of an OFDM message and the second block size may be employed to block code the end of the OFDM message. In another embodiment, more than two different block sizes may be employed. For example, a third block size, smaller than both the first and second block sizes, may be employed to block code the end of the message.

Turning now to FIG. 4, a first block coded OFDM message 320 and a second block coded OFDM message 330 are depicted. The first block coded OFDM message 320 comprises n first blocks 300 and a single second block 310. In the first message 320, the remainder bits of the first block coded OFDM message 320 that did not completely fit into a first block size fit into a single second block 310a. In the second message 330, the remainder bits do not fit into the single second block 310 so two are employed, namely second block 310a and second block 310b. While using two second blocks 310, second block 310a and 310b, may not reduce pad bit overhead versus using the single first block 300, the two second blocks 310a and 310b may reduce the decode latency at the completion of the second block coded OFDM message 320. Because a receiver may be required to know where the OFDM message 320, 320 block size changes from the first block size to the second block size, a header or leading portion of the OFDM messages 320, 330 may include an indication of the number of source information bits. The receiver may determine the number of blocks of the first block size contained in the OFDM messages 320, 330 and hence what blocks to decode according to the first block size and what blocks to decode according to the second block size. If the length of the first block 300 is selected to be twice the length of the second block 310, the following pairs of block sizes may be employed, where the first number in the pair represents the number of bits in the first block 300 and the second number in the pair represents the number of bits in the second block 310: (2400 bits, 1200 bits), (1200 bits, 600 bits), and (600 bits, 300 bits). In other embodiments other pairs of bit lengths may be associated with the first block 300 and the second block 310. Other possible pairs of block sizes include (2400 bits, 600 bits), (2400 bits, 300 bits), and (1200 bits, 300 bits). Other pairs of block sizes are also contemplated by the present disclosure.

While the first block 300 in these examples is twice the length of the second block 310, the length of the first block 300 may have other lengths. The length of the first block 300 may be other rational multiples of the length of the second block 310, including integer multiples of the length of the second block 310. In an embodiment, the first transceiver 102 and the second transceiver 104 may conduct an initialization session in which the length of the first block 300 and the second block 310 is negotiated to obtain a mutually preferred length. For example, different sizes of the second block 310 may be tested during a training portion of initialization to obtain a specified maximum packet error rate. Additionally, while the length of the second block 310 in the example is selected as six symbols to conform to the period of the multi-band OFDM time-frequency codes, in other OFDM systems the length of the second block 310 may be from the length of one OFDM symbol to the length of the number of OFDM symbols that conforms to the period in those other OFDM systems.

The transceivers 102, 104, 106, and 108 described above may be implemented in various ways, including on a single integrated circuit or on a plurality of integrated circuits coupled together such as is well known to those skilled in the art. In one embodiment the transceivers 102, 104, 106, and 108 are implemented as a printed circuit card.

Turning now to FIG. 5, a system 360 illustrates an exemplary piconet member device. A transceiver card 362 comprises an application specific integrated circuit (ASIC) 364 or other form of digital processor, the digital-to-analog converter 210, the analog-to-digital converter 226, the amplifier 214, a receiver amplifier 370, a switch 368, and a transmit/receive antenna 366. The application specific integrated circuit 364 provides the modulation/demodulation and fast Fourier transformer/inverse fast Fourier transformer functions described above with respect to FIG. 3. The switch 368 selects whether the antenna receives a signal and routes the signal to the receiver amplifier 370 or the antenna transmits a signal routed from the amplifier 214. The application specific integrated circuit 364 is coupled to a processor (which may be referred to as a central processing unit or CPU) 382. The CPU 382 provides a communication packet to the application specific integrated circuit 364 and receives communication packets from the application specific integrated circuit 364, for example data link layer packets.

The processor 382 is in communication with memory devices including secondary storage 384, read only memory (ROM) 386, random access memory (RAM) 388, input/output (I/O) 390 devices, and network connectivity devices 392. The processor may be implemented as one or more CPU chips.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage. The RAM 388 is used to store volatile data and perhaps to store instructions. Access to both ROM 386 and RAM 388 is typically faster than to secondary storage 384.

I/O 390 devices may include printers, video monitors, liquid crystal displays (LCDs), touch screen displays, keyboards, keypads, switches, dials, mice, track balls, voice recognizers, card readers, paper tape readers, or other well-known input devices. The network connectivity devices 392 may take the form of modems, modem banks, ethernet cards, universal serial bus (USB) interface cards, serial interfaces, token ring cards, fiber distributed data interface (FDDI) cards, wireless local area network (WLAN) cards, radio transceiver cards such as Global System for Mobile Communications (GSM) radio transceiver cards, and other well-known network devices. These network connectivity 392 devices may enable the processor 382 to communicate with an Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave

Such information, which may include data or instructions to be executed using processor 382 for example, may be received from and outputted to the network, for example, in the form of a computer data baseband signal or signal embodied in a carrier wave. The baseband signal or signal embodied in the carrier wave generated by the network connectivity 392 devices may propagate in or on the surface of electrical conductors, in coaxial cables, in waveguides, in optical media, for example optical fiber, or in the air or free space. The information contained in the baseband signal or signal embedded in the carrier wave may be ordered according to different sequences, as may be desirable for either processing or generating the information or transmitting or receiving the information. The baseband signal or signal embedded in the carrier wave, or other types of signals currently used or hereafter developed, referred to herein as the transmission medium, may be generated according to several methods well known to one skilled in the art.

The processor 382 executes instructions, codes, computer programs, scripts which it accesses from hard disk, floppy disk, optical disk (these various disk based systems may all be considered secondary storage 384), ROM 386, RAM 388, or the network connectivity devices 392.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein, but may be modified within the scope of the appended claims along with their full scope of equivalents. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as directly coupled or communicating with each other may be coupled through some interface or device, such that the items may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

1. A transmitter, comprised of:
a block encoder operable to encode a bit stream using a first block size for a first portion of a message according to an orthogonal frequency division multiplex protocol and a second block size for a second portion of the message.

2. The transmitter of claim 1, wherein the transmitter further includes:
a scrambler component operable to scramble the bit stream received from a higher layer application and to provide the scrambled bit stream to the block encoder;
an interleaver component operable to interleave blocks of bits received from the block encoder;
a mapper operable to mount the output of the interleaver onto quadrature amplitude modulation constellations;
an inverse fast Fourier transformer component operable to transform the output of the mapper to the time domain; and
a digital-to-analog converter operable to convert the output of the inverse fast Fourier transformer component to an analog signal.

3. The transmitter of claim 3, wherein the number of bits contained by the first block size is a rational multiple of the number of bits contained by the second block size.

4. The transmitter of claim 3, wherein the first block size is greater than the second block size, and a length of the second portion of the message is less than or equal to the first block size.

5. The transmitter of claim 2, wherein the second block size is sized to encode six orthogonal frequency division multiplex symbols.

6. The transmitter of claim 1, wherein the length of the first block size and of the second block size are a pair selected from the group of pairs consisting of (2400 bits, 1200 bits), (2400 bits, 600 bits), (2400 bits, 300 bits), (1200 bits, 600 bits), (1200 bits, 300 bits), and (600 bits, 300 bits).

7. A method of communicating, comprising:
block encoding a first portion of a message according to a multi-band orthogonal frequency division multiplex protocol into a plurality of blocks having a first length; and
block encoding a second portion of the message into one or more blocks having a second length, the second length being less than the first length.

8. The method of claim 7, further including:
block encoding a third portion of the message into one or more blocks having a third length, the third length being less than the second length.

9. The method of claim 7, further including:
block decoding the first portion of the message based on the first length;
determining the end of the first portion of the message based on a message length contained in a header in the first portion of the message; and
block decoding the second portion of the message based on the second length.

10. The method of claim 7, wherein the number of bits of the first length is a rational multiple of the number of bits of the second length.

11. The method of claim 7, wherein the second length conforms to the length of six orthogonal frequency division multiplex symbols.

12. The method of claim 7, wherein the second length is in the range of about the length of one orthogonal frequency division multiplex symbol to the length of the number of orthogonal frequency division multiplex symbols that conforms to the period of the time-frequency codes of an orthogonal frequency division multiplex communication standard employed in the communication.

13. The method of claim 7, wherein the second length is selected to promote communications at or below a specified packet error rate.

14. The method of claim 7, wherein the second length is selected to reduce a decoding latency associated with the first length.

15. A communication system, including:
a first transceiver operable, using a first block size to block encode a first portion of a message according to a multi-band orthogonal frequency division multiplex protocol and using a second block size to block encode a second portion of the message, the first transceiver further operable to transmit the message; and
a second transceiver operable to receive the message using a block decoder to decode the first portion of the message based on the first block size and to decode the second portion of the message based on the second block size, wherein the second transceiver distinguishes the first portion of the message from the second portion of the message based on a message length indication provided in the first portion of the message.

16. The system of claim 15, wherein the first transceiver and the second transceiver communicate in accordance with a protocol selected from the group consisting of a Multi-band Orthogonal Frequency Division Multiplex Special Interest Group Physical Layer specification, a WiMedia wireless personal area network protocol, and a Ecma wireless personal area network protocol.

17. The system of claim 15, wherein one of the transceivers is a piconet controller.

18. The system of claim 15, wherein the second block size is selected to reduce decoding latency at the second transceiver while continuing to satisfy a maximum packet error rate specification.

19. The system of claim 15, wherein the first and second transceiver negotiate the first block size and the second block size during an initialization session.

20. The system of claim 15, wherein the number of bits of the first block size is a rational multiple of the number of bits of the second block size.
